(19) United States
(12) Patent Application Publication
(10) Pub. No.: US 2020/0134140 A1
(43) Pub. Date: Apr. 30, 2020

(54) SYSTEMS AND METHODS FOR MANAGEMENT OF SOFTWARE MASTER DATA

(71) Applicant: Quanta Computer Inc., Taoyuan City (TW)

(72) Inventors: Chen-Chung LEE, Taoyuan City (TW); Chia-Hung LIN, Taoyuan City (TW); Hung-Yu YANG, Taoyuan City (TW); Ming-Jen CHEN, Taoyuan City (TW)

(21) Appl. No.: 16/410,244

(22) Filed: May 13, 2019

(30) Foreign Application Priority Data
Oct. 25, 2018 (TW) 107137657

(51) Int. Cl. G06F 21/10; G06F 21/44; G06F 8/65; G06F 16/9035

(52) U.S. Cl. CPC G06F 21/105; G06F 16/9035; G06F 8/65; G06F 21/44

(57) ABSTRACT

A system includes a network communication device, a storage device, and a controller. The network communication device provides a network connection to a terminal device. The storage device stores master data of listed software. The controller obtains a list of software on the terminal device via the network communication device, compares the list with the master data to determine unlisted software on the terminal device, and updates the master data with information of the unlisted software.

### CROSS REFERENCE TO RELATED APPLICATIONS

This Application claims priority of Taiwan Application No. 107137657, filed on Oct. 25, 2018, the entirety of which is incorporated by reference herein.

### BACKGROUND OF THE APPLICATION

### Field of the Application

The application relates generally to software management, and more particularly, to systems and methods for management of software master data.

### Description of the Related Art

Master data management generally refers to management of corporate internal data, including client data, supplier data, product data, data of monitored software, organization data, and employee data, etc., and such data is usually shared between various systems within the corporation to improve corporate performance.

For software asset management, a common practice is to create software master data based on software purchased by the corporation and use the software master data as a reference to monitor if the software installed on each employee's terminal device is listed in the software master data. However, in many cases where some employees may install software that is not listed in the software master data on their terminal devices, vulnerabilities of software audits may result due to a lack of information of the unlisted software in the software master data. One solution to this problem is to provide a purchasing procedure for the administrative department of the corporation to register the software to be purchased, but in many cases, the software to be purchased may fail to include all unlisted software.

Therefore, the failure of conventional software asset management may cause a great risk of penalties for licensing violations to the corporation.

### BRIEF SUMMARY OF THE APPLICATION

In order to solve the aforementioned problem, the present application proposes systems and methods for management of software master data, which are characterized by scanning terminal device(s) to obtain the list of software installed thereon, comparing the list to the software master data to determine the unlisted software on the terminal device(s), and updating the software master data with the information of the unlisted software. Advantageously, the information of all software installed on the terminal devices within a corporation may be managed to prevent software audit vulnerabilities that may cause penalties for licensing violations.

In one aspect of the application, a system comprising a network communication device, a storage device, and a controller is provided. The network communication device is configured to provide a network connection to a terminal device. The storage device is configured to store master data of listed software. The controller is configured to obtain a list of software on the terminal device via the network communication device, compare the list with the master data to determine unlisted software on the terminal device, and update the master data with information of the unlisted software.

Preferably, the controller is further configured to perform a scan disk operation on the terminal device via the network communication device to obtain the list.

Alternatively, the controller is further configured to dispatch an agent program to the terminal device via the network communication device, such that the agent program performs a scan disk operation on the terminal device to obtain the list.

Preferably, the controller is further configured to determine whether each unlisted software is legally licensed, add the information concerning the unlisted software into the master data in response to the unlisted software being legally licensed, and send a notification of request for removing the unlisted software to the terminal device via the network communication device in response to the unlisted software not being legally licensed.

Preferably, the controller is further configured to evaluate a risk level of each unlisted software according to at least one of the following predetermined rules: whether a vendor of each unlisted software belongs to a Business Software Alliance (BSA); whether a license fee of each unlisted software exceeds a predetermined threshold; and whether each unlisted software is open source software.

In another aspect of the application, a method executed by a controller of a system for managing software master data of at least one terminal device is provided. The method comprises the steps of: retrieving master data of listed software from a storage device of the system; obtaining a list of software on the terminal device; comparing the list with the master data to determine unlisted software on the terminal device; and updating the master data with information of the unlisted software.

Preferably, the method further comprises: performing a scan disk operation on the terminal device to obtain the list.

Alternatively, the method further comprises: dispatching an agent program to the terminal device, such that the agent program performs a scan disk operation on the terminal device to obtain the list.

Preferably, the method further comprises: determining whether each unlisted software is legally licensed; adding the information of the unlisted software into the master data in response to the unlisted software being legally licensed; and sending a notification of request for removing the unlisted software to the terminal device in response to the unlisted software not being legally licensed.

Preferably, the method further comprises: evaluating a risk level of each unlisted software according to at least one of the following predetermined rules: whether a vendor of each unlisted software belongs to a BSA; whether a license fee of each unlisted software exceeds a predetermined threshold; and whether each unlisted software is open source software.

Other aspects and features of the application will become apparent to those with ordinary skill in the art upon review of the following descriptions of specific embodiments of the systems and methods for management of software master data.

### BRIEF DESCRIPTION OF THE DRAWINGS

The application can be more fully understood by reading the subsequent detailed description and examples with references made to the accompanying drawings, wherein:

FIG. 1 is a block diagram illustrating a corporate network environment according to an embodiment of the application;

FIG. 2 is a block diagram illustrating an exemplary hardware architecture of the system 150 according to an embodiment of the application;

FIG. 3 is a block diagram illustrating an exemplary software architecture of the method for management of software master data according to an embodiment of the application; and

FIG. 4 is a flow chart illustrating the method for management of software master data according to an embodiment of the application.

### DETAILED DESCRIPTION OF THE APPLICATION

The following description is made for the purpose of illustrating the general principles of the application and should not be taken in a limiting sense. It should be understood that the terms “comprises,” “comprising,” “includes” and “including,” when used herein, specify the presence of stated features, integers, steps, operations, elements, and/or components, but do not preclude the presence or addition of one or more other features, integers, steps, operations, elements, components, and/or groups thereof.

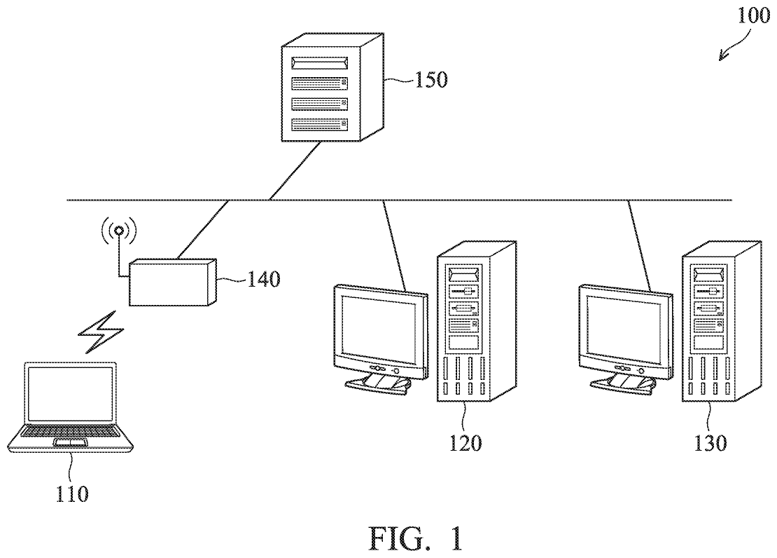

FIG. 1 is a block diagram illustrating a corporate network environment according to an embodiment of the application.

The corporate network environment 100 may include multiple terminal devices 110 to 130, a wireless Access Point (AP) 140, and a system 150, wherein the system 150 may connect to the terminal devices 110 to 130 via wired or wireless connections for management of software master data.

Each of the terminal devices 110 to 130 may be any computing device with a network communication function, such as a laptop computer, a desktop computer, a smartphone, a panel Personal Computer (PC), or a server. For example, as shown in FIG. 1, the terminal device 110 may be a laptop computer connected to the corporate network via the wireless AP 140, while the terminal devices 120 and 130 may be desktop computers connected to the corporate network via wired connections, such as Ethernet connections, optical network connections, Asymmetric Digital Subscriber Line (ADSL) connections, Twisted Pair connections, or Coaxial cable connections.

In particular, each of the terminal devices 110 to 130 may have the same or different software, including software that can be used only when installed, and software that can be used without installation, wherein some of the software may not be listed in the software master data maintained by the system 150. Specifically, the software that can be used without installation may also be called as standalone software or portable software.

The wireless AP 140 may utilize any wireless communication technology, such as the Wireless-Fidelity (Wi-Fi) technology, the Bluetooth technology, or the Zigbee technology, to establish a Wireless Local Area Network (WLAN) to provide wireless services to any terminal device within the coverage of the WLAN. The wireless AP 140 may connect to the corporate network via an Ethernet connection. The wireless AP 140 typically receives, buffers, and transmits data from and to any terminal device within the coverage of the WLAN.

The system 150 may be a server or any computing device with a network communication function, which is responsible for maintaining the master data of listed software (i.e., software that is under corporate administration). In one embodiment, the master data of listed software may be created based on the information of the software purchased by the corporate.

In addition, the system 150 may perform scan disk operations on the terminal devices 110 to 130 to obtain a list of software thereon, and compare the list with the master data of listed software to determine unlisted software on the terminal devices 110 to 130. After that, the information of the unlisted software may be updated to the master data.

It should be noted that the corporate network environment 100 depicted in FIG. 1 is for illustrative purposes only and is not intended to limit the scope of the application. Alternatively, the corporate network environment 100 may include less or more terminal devices. For example, the corporate network environment 100 may include only one terminal device, or more than three terminal devices, wherein each terminal device may connect to the corporate network via a wired or wireless connection.

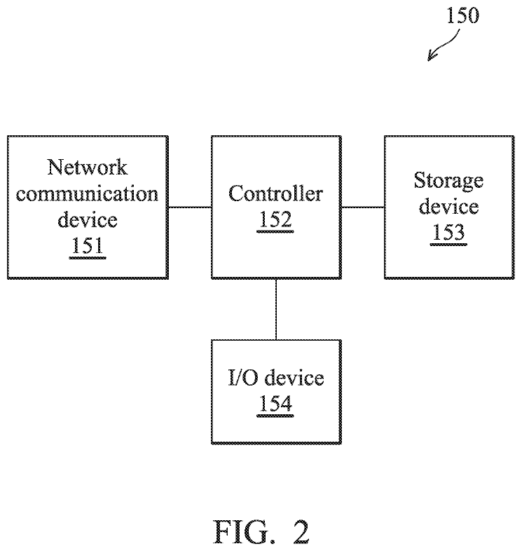

FIG. 2 is a block diagram illustrating an exemplary hardware architecture of the system 150 according to an embodiment of the application.

As shown in FIG. 2, the system 150 may include a network communication device 151, a controller 152, a storage device 153, and an Input/Output (I/O) device 154.

The network communication device 151 is responsible for providing network connections to the corporate network and to the terminal devices 110 to 130. The network communication device 151 may provide wired or wireless connections using a wired communication technology, such as the Ethernet technology, the ADSL technology, the optical network technology, the twisted-pair network technology, or the coaxial cable network technology, or using a wireless communication technology, such as the Wi-Fi technology, the Bluetooth technology, or the Zigbee technology.

The controller 152 may be a general-purpose processor, a Micro Control Unit (MCU), an Application Processor (AP), or a Digital Signal Processor (DSP), which includes various circuits for performing the functions of data processing and computing, controlling the network communication device 151 to provide network connections to the terminal devices 110 to 130, reading or storing data from or to the storage device 153, and receiving user input or outputting feedback signals to users via the I/O device 154.

In particular, the controller 152 coordinates the operations of the network communication device 151, the storage device 153, and the I/O device 154, to carry out the method for management of software master data.

As will be appreciated by persons skilled in the art, the circuits in the controller 152 will typically comprise transistors that are configured in such a way as to control the operation of the circuitry in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 153 is a non-transitory computer-readable storage medium, such as a Random Access Memory (RAM), or a FLASH memory, or a magnetic storage device, such as a hard disk or a magnetic tape, or an optical disc, or any combination thereof for storing software master data and instructions or program code of applications and/or communication protocols. The software master data may be stored in the form of database in the storage device 153.

In particular, the storage device 153 stores instructions or program code of the method for management of software master data, which are/is loaded and executed by the controller 152.

The I/O device 154 may include one or more buttons, a keyboard, a mouse, a touch pad, a video camera, a microphone, and/or a speaker, etc., serving as an Man-Machine Interface (MMI) for interaction with users (e.g., personnel of the Information and Communication (IC) department or the Management Information System (MIS) department).

It should be understood that the components described in the embodiment of FIG. 2 are for illustrative purposes only and are not intended to limit the scope of the application. For example, the system 150 may include more components, such as a power supply, and/or a display device (e.g., a Liquid-Crystal Display (LCD), Light-Emitting Diode (LED) display, or Electronic Paper Display (EPD), etc.). The power supply may be a portable/replaceable battery providing power to all the other components of the system 150. The display may provide a display function for displaying visual content (e.g., texts or images).

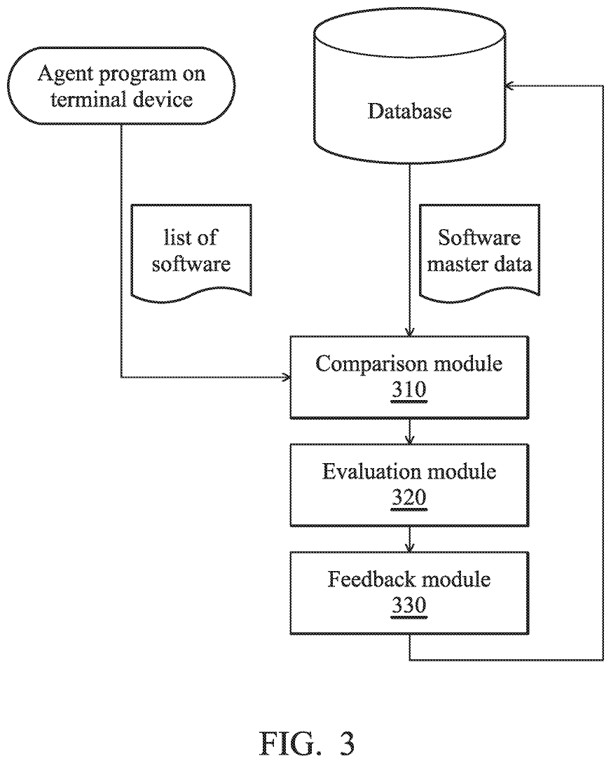

FIG. 3 is a block diagram illustrating an exemplary software architecture of the method for management of software master data according to an embodiment of the application.

In this embodiment, the method for management of software master data is executed by the system 150. Specifically, the method for management of software master data may be implemented in program codes as multiple software modules which may be loaded and executed by the controller 152.

As shown in FIG. 3, the software architecture includes a comparison module 310, an evaluation module 320, and a feedback module 330.

The comparison module 310 is responsible for retrieving software master data (i.e., master data of listed software) from the database, receiving the list of software on the terminal device, which is obtained by an agent program performing a scan disk operation on the terminal device, and comparing the software master data with the list to determine unlisted software on the terminal device.

In this embodiment, the system 150 may dispatch an agent program to each terminal device, such that the agent program performs a scan disk operation on each terminal device to obtain the list of software on each terminal device.

In another embodiment, the system 150 may connect to each terminal device and perform a scan disk operation on each terminal device to obtain the list of software on each terminal device, without dispatching an agent program to each terminal device.

The evaluation module 320 is responsible for checking on the unlisted software to determine the number of pieces of each unlisted software, determine whether each unlisted software is legally licensed, and evaluate the risk level of each unlisted software, thereby generating a decision to remove or purchase the unlisted software.

Specifically, the number of pieces of each unlisted software may be determined by categorizing the unlisted software by name, counting the number of pieces of each unlisted software having the same name, and sorting the unlisted software by the counted numbers, so that the determination of whether each unlisted software is legally licensed may be performed for the unlisted software one by one in the sorted order.

Specifically, the determination of whether each unlisted software is legally licensed may be performed by checking if each unlisted software has a legal license. In one embodiment, the information of the legal license may be found in the “About” page of the unlisted software.

Specifically, the evaluation of the risk level of each unlisted software may be performed according to one or more predetermined rules, including whether the vendor of the unlisted software belongs to the Business Software Alliance (BSA), whether the license fee of the unlisted software exceeds a predetermined threshold, and whether the unlisted software is open source software.

For example, if the vendor of the unlisted software belongs to the BSA, the risk level of the unlisted software may be evaluated as high; otherwise, if the vendor of the unlisted software does not belong to the BSA, the risk level of the unlisted software may be evaluated as low. If the license fee of the unlisted software exceeds a million dollars, the risk level of the unlisted software may be evaluated as high; otherwise, if the license fee of the unlisted software is less than a million dollars, the risk level of the unlisted software may be evaluated as low. If the unlisted software is open source software, the risk level of the unlisted software may be evaluated as low; otherwise, if the unlisted software is not open source software (e.g., the unlisted software is licensed software), the risk level of the unlisted software may be evaluated as high.

In one embodiment, if the unlisted software is not legally licensed, the system 150 may send a notification of request for removing the unlisted software to the terminal device. If the user of the terminal device still needs to use this unlisted software, he/she may file a purchase request for this unlisted software to the administrative department of the corporate. When the purchasing procedure is successfully completed, the information of the unlisted software will be added to the software master data maintained in the database and the unlisted software will become listed software.

The feedback module 330 is responsible for sending the information (e.g., name, version, vendor, applicable platform, and use) of the unlisted software, the result of the determination of whether each unlisted software is legally licensed, and the result of the evaluation of the risk level of each unlisted software, to the database to update the software master data.

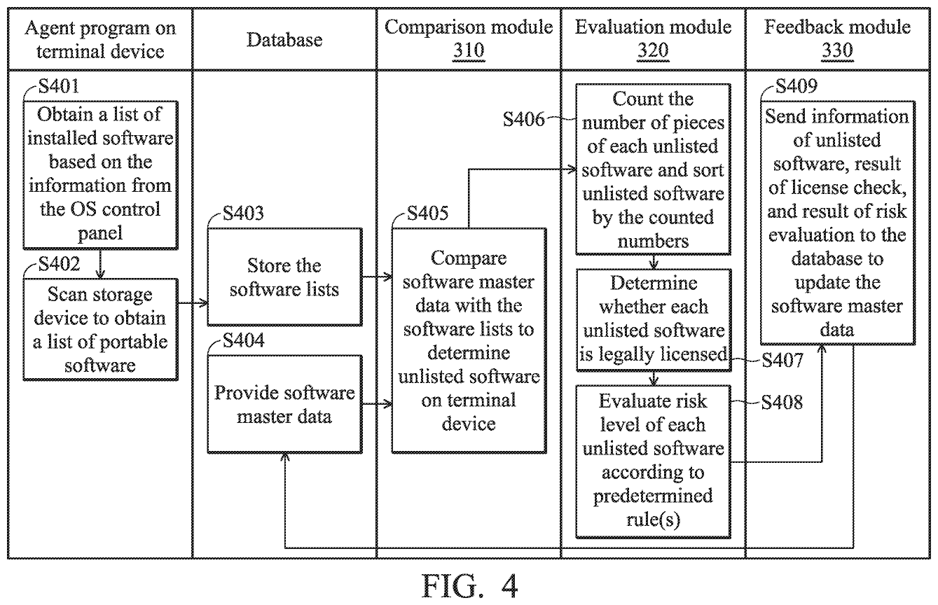

FIG. 4 is a flow chart illustrating the method for management of software master data according to an embodiment of the application.

To begin with, each agent program on each terminal device obtains a list of installed software on the terminal device based on the information from the control panel of the Operating System (OS) of the terminal device (step S401), and obtains a list of portable software on the terminal device by scanning the storage device (e.g., a hard drive or memory) of the terminal device (step S402).

Specifically, the installed software may refer to software that can be used only when installed, while the portable software may also be called standalone software and may refer to software that can be used without installation.

In one embodiment, if the operating system of a terminal device is a Windows system, the agent program thereon may use the “Add or Remove Programs” function of the Windows control panel to obtain the list of installed software.

In one embodiment, an agent program may scan for all executable files on a terminal device, and then exclude the ones corresponding to installed software, thereby obtaining the list of portable software on the terminal device.

Next, the database stores the software lists, including the lists of installed software and the lists of portable software, obtained from a plurality of terminal devices by the agent programs (step S403), and provides the software master data to the comparison module 310 (step S404).

Subsequently, the comparison module 310 compares the software master data with the software lists obtained by the agent programs to determine unlisted software on the terminal devices (step S405). Specifically, the comparison module 310 may check on the software in the software lists, one by one, to see if the software master data has information corresponding to the software, and if the software master data does not have information corresponding to the software, the software may be determined as unlisted software.

The evaluation module 320 counts the number of pieces of each unlisted software and sorts the unlisted software by the counted numbers (step S406). Then, the evaluation module 320 determines whether each unlisted software is legally licensed (step S407), and evaluates the risk level of each unlisted software according to one or more predetermined rules (step S408).

After that, the feedback module 330 sends the information of the unlisted software, the result of the determination of whether each unlisted software is legally licensed, and the result of the evaluation of the risk level of each unlisted software, to the database to update the software master data (step S409).

In view of the foregoing embodiments, it will be appreciated that the systems and methods for management of software master data are characterized by periodically or aperiodically obtaining information of the software used by the terminal devices for counting the number of software, evaluating the software, and updating the software master data. Advantageously, the current status of software usage within a corporate may be constantly updated to improve the efficiency and precision of software master data management, such that the risk of penalties for licensing violations may be greatly reduced.

While the application has been described by way of example and in terms of preferred embodiment, it should be understood that the application cannot be limited thereto. Those who are skilled in this technology can still make various alterations and modifications without departing from the scope and spirit of this application. Therefore, the scope of the present application shall be defined and protected by the following claims and their equivalents.

What is claimed is:

1. A system, comprising:
a network communication device, configured to provide a network connection to a terminal device;
a storage device, configured to store master data of listed software; and
a controller, configured to obtain a list of software on the terminal device via the network communication device, compare the list with the master data to determine unlisted software on the terminal device, and update the master data with information of the unlisted software.

2. The system of claim 1, wherein the controller is further configured to perform a scan disk operation on the terminal device via the network communication device to obtain the list.

3. The system of claim 1, wherein the controller is further configured to dispatch an agent program to the terminal device via the network communication device, such that the agent program performs a scan disk operation on the terminal device to obtain the list.

4. The system of claim 1, wherein the controller is further configured to determine whether each unlisted software is legally licensed, add the information concerning the unlisted software into the master data in response to the unlisted software being legally licensed, and send a notification of request for removing the unlisted software to the terminal device via the network communication device in response to the unlisted software not being legally licensed.

5. The system of claim 1, wherein the controller is further configured to evaluate a risk level of each unlisted software according to at least one of the following predetermined rules:
whether a vendor of each unlisted software belongs to a Business Software Alliance (BSA);
whether a license fee of each unlisted software exceeds a predetermined threshold; and
whether each unlisted software is open source software.

6. A method, executed by a controller of a system for managing software master data of at least one terminal device, the method comprising:
retrieving master data of listed software from a storage device of the system;
obtaining a list of software on the terminal device;
comparing the list with the master data to determine unlisted software on the terminal device; and
updating the master data with information of the unlisted software.

7. The method of claim 6, further comprising:
performing a scan disk operation on the terminal device to obtain the list.

8. The method of claim 6, further comprising:
dispatching an agent program to the terminal device, such that the agent program performs a scan disk operation on the terminal device to obtain the list.

9. The method of claim 6, further comprising:
determining whether each unlisted software is legally licensed;
adding the information of the unlisted software into the master data in response to the unlisted software being legally licensed; and
sending a notification of request for removing the unlisted software to the terminal device in response to the unlisted software not being legally licensed.

10. The method of claim 9, further comprising:
evaluating a risk level of each unlisted software according to at least one of the following predetermined rules:
whether a vendor of each unlisted software belongs to a Business Software Alliance (BSA);
whether a license fee of each unlisted software exceeds a predetermined threshold; and
whether each unlisted software is open source software.
